(19) United States
(12) Patent Application Publication
(10) Pub. No.: US 2018/0046663 A1
(43) Pub. Date: Feb. 15, 2018

(54) SYSTEM AND METHOD FOR COMPLETING ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/668,426

(22) Filed: Aug. 3, 2017

Related U.S. Application Data
(63) Continuation-in-part of application No. 15/361,934, filed on Nov. 28, 2016.
(60) Provisional application No. 62/371,228, filed on Aug. 5, 2016.
(60) Provisional application No. 62/260,553, filed on Nov. 29, 2015.
(60) Provisional application No. 62/261,355, filed on Dec. 1, 2015.

(51) Int. Cl. G06F 17/30; G06K 9/00; G06K 9/34

(52) U.S. Cl. CPC G06F 17/30371; G06F 17/30377; G06F 17/3056; G06K 9/344; G06K 9/00442; G06Q 30/04

(57) ABSTRACT

A system and method for completing an electronic document. The method includes analyzing the electronic document to determine at least one transaction parameter, wherein the electronic document includes at least partially unstructured data; creating a template for the electronic document, wherein the template is a structured dataset including at least one data element, wherein each transaction parameter is a value of one of the at least one data element; retrieving, based on the template, complementary data for one of the at least one data element when the data element is incomplete; generating, based on the complementary data and the incomplete first data element, a complete second data element; and associating the complete second data element with the electronic document.

### CROSS-REFERENCE TO RELATED APPLICATIONS

This application claims the benefit of U.S. Provisional Application No. 62/371,228 filed on Aug. 5, 2016. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to analyzing electronic documents, and more particularly to completing electronic documents with missing or unclear data.

### BACKGROUND

Customers can place orders for services such as travel and accommodations from merchants in real-time over the web. These orders can be received and processed immediately. However, payments for the orders typically require more time to complete and, in particular, to secure the money being transferred. Therefore, merchants typically require the customer to provide assurances of payment in real-time while the order is being placed. As an example, a customer may input credit card information pursuant to a payment, and the merchant may verify the credit card information in real-time before authorizing the sale. The verification typically includes determining whether the provided information is valid (i.e., that a credit card number, expiration date, PIN code, and/or customer name match known information).

Upon receiving such assurances, a purchase order may be generated for the customer. The purchase order provides evidence of the order such as, for example, a purchase price, goods and/or services ordered, and the like. Later, an invoice for the order may be generated. While the purchase order is usually used to indicate which products are requested and an estimate or offering for the price, the invoice is usually used to indicate which products were actually provided and the final price for the products. Frequently, the purchase price as demonstrated by the invoice for the order is different from the purchase price as demonstrated by the purchase order. As an example, if a guest at a hotel initially orders a 3-night stay but ends up staying a fourth night, the total price of the purchase order may reflect a different total price than that of the subsequent invoice. Cases in which the total price of the invoice is different from the total price of the purchase order are difficult to track, especially in large enterprises accepting many orders daily (e.g., in a large hotel chain managing hundreds or thousands of hotels in a given country). The differences may cause errors in recordkeeping for enterprises.

As businesses increasingly rely on technology to manage data related to operations such as invoice and purchase order data, suitable systems for properly managing and validating data have become crucial to success. Particularly for large businesses, the amount of data utilized daily by businesses can be overwhelming. Accordingly, manual review and validation of such data is impractical, at best. However, disparities between recordkeeping documents can cause significant problems for businesses such as, for example, failure to properly report earnings to tax authorities.

Some solutions exist for automatically recognizing information in scanned documents (e.g., invoices and receipts) or other unstructured electronic documents (e.g., unstructured text files). Such solutions often face challenges in accurately identifying and recognizing characters and other features of electronic documents. Moreover, degradation in content of the input unstructured electronic documents typically result in higher error rates. As a result, existing image recognition techniques are not completely accurate under ideal circumstances (i.e., very clear images), and their accuracy often decreases dramatically when input images are less clear. Moreover, missing or otherwise incomplete data can result in errors during subsequent use of the data. Many existing solutions cannot identify missing data unless, e.g., a field in a structured dataset is left incomplete.

In addition, existing image recognition solutions may be unable to accurately identify some or all special characters (e.g., “!,” “@,” “#,” “$,” “©,” “%,” “&,” etc.). As an example, some existing image recognition solutions may inaccurately identify a dash included in a scanned receipt as the number “1.” As another example, some existing image recognition solutions cannot identify special characters such as the dollar sign, the yen symbol, etc.

Further, such solutions may face challenges in preparing recognized information for subsequent use. Specifically, many such solutions either produce output in an unstructured format, or can only produce structured output if the input electronic documents are specifically formatted for recognition by an image recognition system. The resulting unstructured output typically cannot be processed efficiently. In particular, such unstructured output may contain duplicates, and may include data that requires subsequent processing prior to use.

Typically, to reclaim VATs paid during a transaction, evidence in the form of documentation indicating information related to the transaction (such as an invoice or receipt) must be submitted to an appropriate refund authority (e.g., a tax agency of the country refunding the VAT). If the information in the submitted documentation does not include all information required to confirm the veracity of the reclaim request, the reclaim is denied. To this end, some enterprises use human checkers to manually confirm that required information is provided. Other enterprises may use automatic information checking systems, but these automatic systems typically require that the data be provided in a known format, which is often impossible when receipts come from different merchants with different receipt formats. Further, such solutions typically only identify incomplete documents and notify the enterprise of the incompleteness, but do not complete the documents such that they can still be submitted to obtain a refund.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for completing an electronic document. The method comprises: analyzing the electronic document to determine at least one transaction parameter, wherein the electronic document includes at least partially unstructured data; creating a template for the electronic document, wherein the template is a structured dataset including at least one data element, wherein each transaction parameter is a value of one of the at least one data element; retrieving, based on the template, complementary data for one of the at least one data element when the data element is incomplete; generating, based on the complementary data and the incomplete data element, a complete data element; and associating the complete data element with the electronic document.

Certain embodiments disclosed herein also include a non-transitory computer readable medium having stored thereon instructions for causing a processing circuitry to perform a process for completing an electronic document, the process comprising: analyzing the electronic document to determine at least one transaction parameter, wherein the electronic document includes at least partially unstructured data; creating a template for the electronic document, wherein the template is a structured dataset including at least one data element, wherein each transaction parameter is a value of one of the at least one data element; retrieving, based on the template, complementary data for one of the at least one data element when the data element is incomplete; generating, based on the complementary data and the incomplete data element, a complete data element; and associating the complete data element with the electronic document.

Certain embodiments disclosed herein also include a system for completing an electronic document. The system comprises: a processing circuitry; and a memory, the memory containing instructions that, when executed by the processing circuitry, configure the system to: analyze the electronic document to determine at least one transaction parameter, wherein the electronic document includes at least partially unstructured data; create a template for the electronic document, wherein the template is a structured dataset including at least one data element, wherein each transaction parameter is a value of one of the at least one data element; retrieve, based on the template, complementary data for one of the at least one data element when the data element is incomplete; generate, based on the complementary data and the incomplete data element, a complete data element; and associate the complete data element with the electronic document.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a validation system according to an embodiment.

FIG. 3 is a flowchart illustrating a method for completing an electronic document according to an embodiment.

FIG. 4 is a flowchart illustrating a method for creating a dataset based on at least one electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for completing an electronic document including data of a transaction. In an embodiment, a dataset is created based on the electronic document. A template of transaction attributes is created based on the dataset. Based on the template created for the electronic document, it is determined whether a data element in the electronic document is incomplete. When it is determined that a data element in the electronic document is incomplete, one or more data sources are searched for complementary data for the incomplete data element. Based on the incomplete data element and the complementary data, a complete data element is generated. The complete data element is associated with the electronic document.

The disclosed embodiments allow for automatic completion of, for example, documents providing evidentiary proof of transactions. More specifically, the disclosed embodiments include providing structured dataset templates for electronic documents, thereby allowing for more accurately identifying incomplete data elements in electronic documents that are unstructured, semi-structured, or otherwise lacking a known structure. For example, a price that appears smudged in an image of an invoice may be identified based on data in a “price” field of a structured template, and complementary price data may be used to generate a complete price data element.

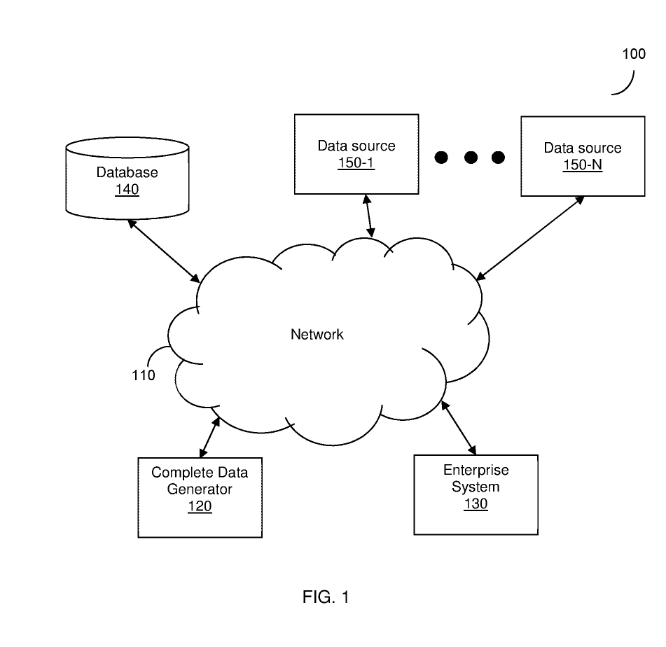

FIG. 1 shows an example network diagram 100 utilized to describe the various disclosed embodiments. In the example network diagram 100, a complete data generator 120, an enterprise system 130, a database 140, and a plurality of data sources 150-1 through 150-N (hereinafter referred to individually as a data source 150 and collectively as data sources 150, merely for simplicity purposes), are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to purchases made by the enterprise or representatives of the enterprise as well as data related to the enterprise itself. The enterprise may be, but is not limited to, a business whose employees may purchase goods and services subject to VAT taxes while abroad. The enterprise system 130 may be, but is not limited to, a server, a database, an enterprise resource planning system, a customer relationship management system, or any other system storing relevant data.

The data stored by the enterprise system 130 may include, but is not limited to, electronic documents (e.g., an image file showing, for example, a scan of an invoice, a text file, a spreadsheet file, etc.). Each electronic document may show, e.g., an invoice, a tax receipt, a purchase number record, a VAT reclaim request, and the like. Data included in each electronic document may be structured, semi-structured, unstructured, or a combination thereof. The structured or semi-structured data may be in a format that is not recognized by the complete data generator 120 and, therefore, may be treated as unstructured data.

The database 140 may store complete data elements generated by the complete data generator 120 and associated electronic documents. The data sources 150 store at least potential complementary data related to transactions. The data sources 150 may include, but are not limited to, servers or devices of merchants, tax authority servers, accounting servers, a database associated with an enterprise, and the like.

In an embodiment, the complete data generator 120 is configured to create a template based on transaction parameters identified using machine vision of an electronic document indicating information related to a transaction. In a further embodiment, the complete data generator 120 may be configured to retrieve the electronic document from, e.g., the enterprise system 130. Based on the created template, the complete data generator 120 is configured to determine whether any of the data elements in the template are incomplete and, if so, to search for complementary data to be utilized for generating complete data elements.

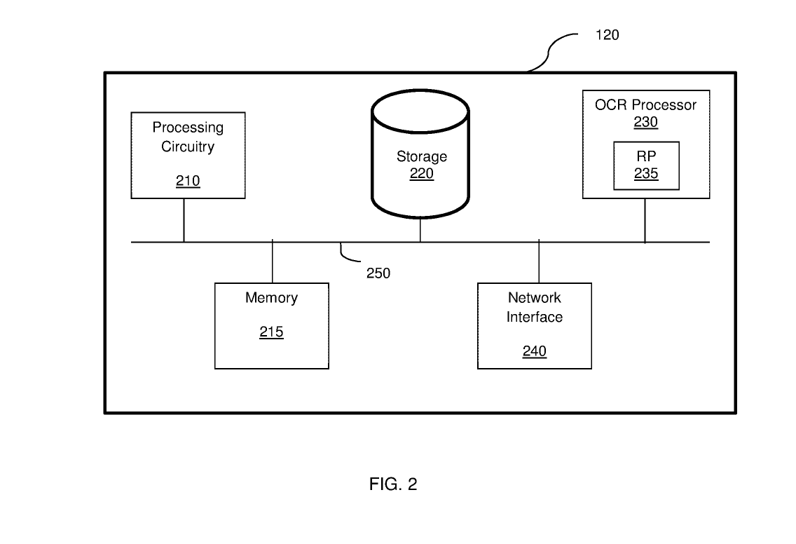

In an embodiment, the complete data generator 120 is configured to create datasets based on electronic documents including data at least partially lacking a known structure (e.g., unstructured data, semi-structured data, or structured data having an unknown structure). To this end, the complete data generator 120 may be further configured to utilize optical character recognition (OCR) or other image processing to determine data in the electronic document. The complete data generator 120 may therefore include or be communicatively connected to a recognition processor (e.g., the recognition processor 235, FIG. 2).

In an embodiment, the complete data generator 120 is configured to analyze the created datasets to identify transaction parameters related to transactions indicated in the electronic documents.

In an embodiment, the complete data generator 120 is configured to create a template based on the created dataset for an electronic document. Each template is a structured dataset including the identified transaction parameters for a transaction. More specifically, each template may include a data element in each field, where each transaction parameter is a value of the data element.

Using structured templates for completing electronic documents allows for more efficient and accurate completion than, for example, by utilizing unstructured data. Specifically, incomplete data elements may be identified with respect to fields of the structured templates, and complementary data may be searched with respect to fields that are missing data.

In an embodiment, based on the created template, the complete data generator 120 is configured to determine whether any of the data elements are incomplete. A data element may be incomplete if the data element is unclear or at least partially missing. For each incomplete data element, the complete data generator 120 is configured to search in one or more of the data sources for complementary data. The search may be based on the values of the incomplete data elements, the respective fields of the template, other data in the template, or a combination thereof. Based on the complementary data found during the search and the incomplete data element, the complete data generator 120 is configured to generate a complete data element.

In an embodiment, the complete data generator 120 is configured to associate the complete data element with the electronic document. The complete data generator 120 may be further configured to store the complete data element in the template. The complete data generator 120 may be configured to generate a notification indicating the generated complete data element.

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

FIG. 2 is an example schematic diagram of the complete data generator 120 according to an embodiment. The complete data generator 120 includes a processing circuitry 210 coupled to a memory 215, a storage 220, and a network interface 240. In an embodiment, the complete data generator 120 may include an optical character recognition (OCR) processor 230. In another embodiment, the components of the complete data generator 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to complete electronic documents, as discussed herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in unstructured data sets. Specifically, in an embodiment, the OCR processor 230 is configured to identify at least characters in the unstructured data. The identified characters may be utilized to create a dataset including data required for verification of a request.

The network interface 240 allows the complete data generator 120 to communicate with the enterprise system 130, the database 140, the data sources 150, or a combination of, for the purpose of, for example, collecting metadata, retrieving data, storing data, and the like.

It should be understood that the embodiments described herein are not limited to the specific architecture illustrated in FIG. 2, and other architectures may be equally used without departing from the scope of the disclosed embodiments.

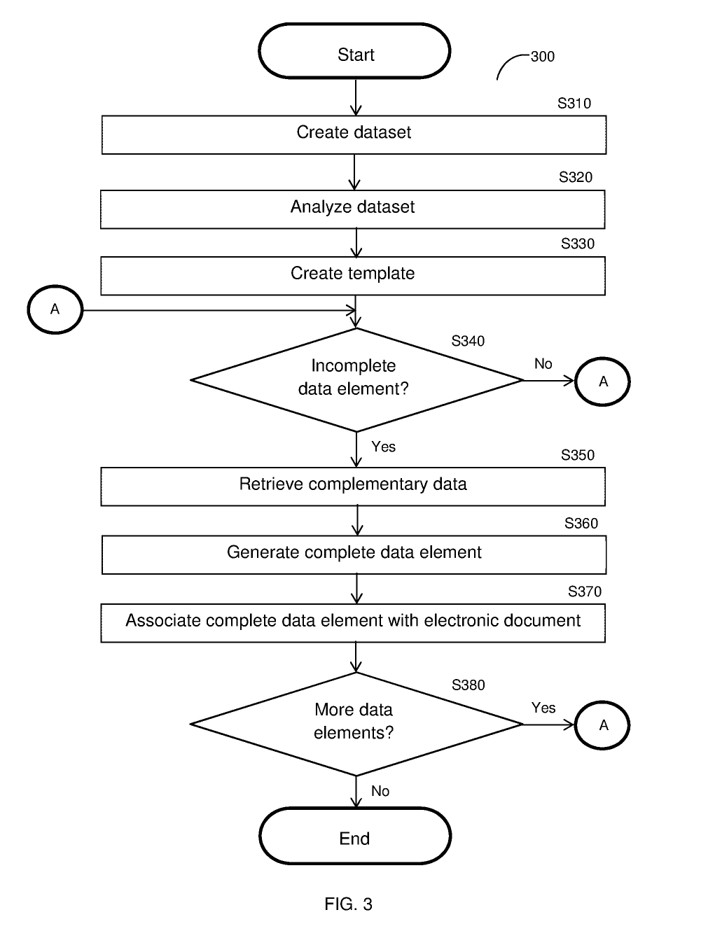

FIG. 3 is an example flowchart 300 illustrating a method for completing an electronic document according to an embodiment. In an embodiment, the method may be performed by a complete data generator (e.g., the complete data generator 120). In an example implementation, the electronic document may be an electronic receipt (e.g., an image showing a scanned receipt).

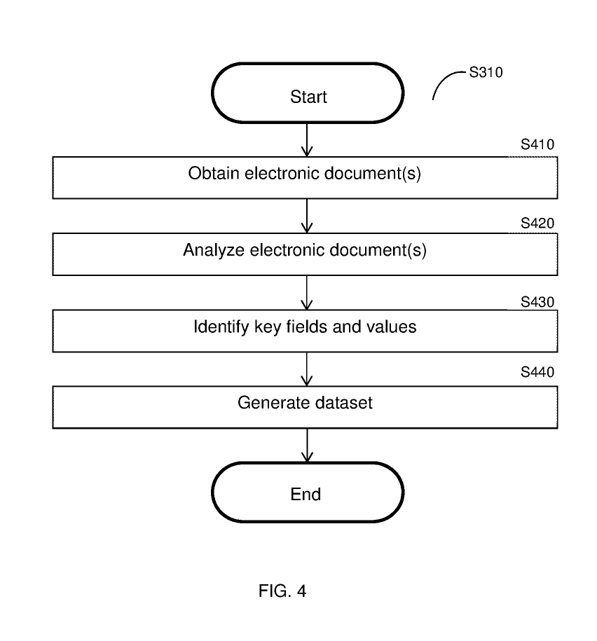

At S310, a dataset is created based on the electronic document including information related to a transaction. The electronic document may include, but is not limited to, unstructured data, semi-structured data, structured data with structure that is unanticipated or unannounced, or a combination thereof. In an embodiment, S310 may further include analyzing the electronic document using optical character recognition (OCR) to determine data in the electronic document, identifying key fields in the data, identifying values in the data, or a combination thereof. Creating datasets based on electronic documents is described further herein below with respect to FIG. 4.

At S320, the created dataset is analyzed. In an embodiment, analyzing the dataset may include, but is not limited to, determining transaction parameters such as, but not limited to, at least one entity identifier (e.g., a consumer enterprise identifier, a merchant enterprise identifier, or both), information related to the transaction (e.g., a date, a time, a price, a type of good or service sold, etc.), or both. In a further embodiment, analyzing the dataset may also include identifying the transaction based on the first dataset.

At S330, a template is created based on the dataset. The template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, identifying incomplete date elements in structured templates may result in more accurate identification of incomplete data elements based on unstructured data. Additionally, searching for complementary data based on incomplete data elements identified in structured templates may be performed with respect to fields of the templates, thereby more accurately identifying complementary data.

At S340, based on the created template, it is determined whether a data element is incomplete and, if so, execution continues with S350; otherwise, execution may continue with S340. Execution may continue until completeness of each data element in the created template has been determined. A data element may be incomplete if the data element is unclear or is missing in whole or in part. For example, if a supplier ID data element is missing from the “Supplier ID” field of the template, the data element may be determined to be incomplete. As another example, if a value of a supplier name data element is unclear, the data element may be determined to be incomplete.

Each data element defines a unit of data stored in the field of the created template. Whether a data element is incomplete may be determined based on one or more completeness rules and the value of the data unit in the template that is defined by the data element. The completeness rules may vary depending on the field of the data element. Example data elements include, but are not limited to, supplier identifier, time pointer, VAT amount, price, and the like.

At S350, when it is determined that a data element is incomplete, complementary data is retrieved for the incomplete data element. The complementary data may be retrieved based on the value of the incomplete data element, the field of the template in which the value is stored, other data in the template, or a combination thereof. To this end, S350 may include comparing the value of the incomplete data element to values of one or more potential complementary data elements. The complementary data may include, but is not limited to, a character, a series of characters, a word, a sentence, a portion of a sentence, a numerical value, and the like. For example, when a supplier ID number is incomplete, the supplier ID number may be retrieved and utilized as complementary data. The complementary data supplier ID number may be retrieved based on a partially missing supplier ID number and previous electronic documents including the full supplier ID number.

At S360, based on the incomplete data element and the complementary data, a complete data element is generated. In an embodiment, S360 may further include generating a notification indicating the complete data element.

At S370, the complete data element is associated with the electronic document. In an embodiment, S370 may further include storing the value of the complete data element in the respective field of the incomplete data element in the template.

At S380, it is checked whether additional data elements are to be processed and, if so, execution continues with S340; otherwise, execution terminates. In an embodiment, completeness of all data elements may be determined and any incomplete data elements may be completed, thereby resulting in a complete electronic document.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to 12/12/2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for completing an electronic document, comprising:
analyzing the electronic document to determine at least one transaction parameter, wherein the electronic document includes at least partially unstructured data;
creating a template for the electronic document, wherein the template is a structured dataset including at least one data element, wherein each transaction parameter is a value of one of the at least one data element;
retrieving, based on the template, complementary data for a first data element of the at least one data element when the first data element is incomplete;
generating, based on the complementary data and the incomplete first data element, a complete second data element; and
associating the complete second data element with the electronic document.

2. The method of claim 1, wherein determining the at least one transaction parameter further comprises:
identifying, in the electronic document, at least one key field and at least one value;
creating, based on the electronic document, a dataset, wherein the created dataset includes the at least one key field and the at least one value; and
analyzing the created dataset, wherein the at least one transaction parameter is determined based on the analysis.

3. The method of claim 2, wherein identifying the at least one key field and the at least one value further comprises:
analyzing the electronic document to determine data in the electronic document; and
extracting, based on a predetermined list of key fields, at least a portion of the determined data, wherein the at least a portion of the determined data matches at least one key field of the predetermined list of key fields.

4. The method of claim 3, wherein analyzing the electronic document further comprises:
performing optical character recognition on the electronic document.

5. The method of claim 1, wherein the incomplete first data element is at least one of: unclear, and at least partially missing.

6. The method of claim 1, wherein retrieving the complementary data further comprises:
comparing a value of the incomplete first data element to values of potential complementary data.

7. The method of claim 1, further comprising:
generating a notification indicating the complete second data element.

8. A non-transitory computer readable medium having stored thereon instructions for causing a processing circuitry to perform a process for completing an electronic document, the process comprising:
analyzing the electronic document to determine at least one transaction parameter, wherein the electronic document includes at least partially unstructured data;
creating a template for the electronic document, wherein the template is a structured dataset including at least one data element, wherein each transaction parameter is a value of one of the at least one data element;
retrieving, based on the template, complementary data for one of the at least one data element when the data element is incomplete;
generating, based on the complementary data and the incomplete first data element, a complete second data element; and
associating the complete second data element with the electronic document.

9. A system for completing an electronic document, comprising:
a processing circuitry; and
a memory, the memory containing instructions that, when executed by the processing circuitry, configure the system to:
analyze the electronic document to determine at least one transaction parameter, wherein the electronic document includes at least partially unstructured data;
create a template for the electronic document, wherein the template is a structured dataset including at least one data element, wherein each transaction parameter is a value of one of the at least one data element;
retrieve, based on the template, complementary data for a first data element of the at least one data element when the first data element is incomplete;
generate, based on the complementary data and the incomplete first data element, a complete second data element; and
associate the complete second data element with the electronic document.

10. The system of claim 9, wherein the system is further configured to:
identify, in the electronic document, at least one key field and at least one value;
create, based on the electronic document, a dataset, wherein the created dataset includes the at least one key field and the at least one value; and
analyze the created dataset, wherein the at least one transaction parameter is determined based on the analysis.

11. The system of claim 10, wherein the system is further configured to:
analyze the electronic document to determine data in the electronic document; and
extract, based on a predetermined list of key fields, at least a portion of the determined data, wherein the at least a portion of the determined data matches at least one key field of the predetermined list of key fields.

12. The system of claim 11, wherein the system is further configured to:
perform optical character recognition on the electronic document.

13. The system of claim 9, wherein the incomplete first data element is at least one of:
unclear, and at least partially missing.

14. The system of claim 9, wherein the system is further configured to:
compare a value of the incomplete first data element to values of potential complementary data.

15. The system of claim 9, wherein the system is further configured to:
generate a notification indicating the complete second data element.
